(19) United States
(12) Patent Application Publication
(10) Pub. No.: US 2003/0222116 A1
(43) Pub. Date: Dec. 4, 2003

(54) Nail guiding mechanism of nailing gun

(76) Inventors: Ming Hsien Chen, Ta-Li City (TW); Yuan Long Hsu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/156,146

(22) Filed: May 29, 2002

(51) Int. Cl. B25C 1/04

(52) U.S. Cl. 227/139; 227/120

(57) ABSTRACT

A nail guiding mechanism of nailing gun composed of a gun body, a nail magazine and the nail guiding mechanism. The nail guiding mechanism includes a bottom board, a middle board and a top board. The bottom board is connected between the gun body and the nail magazine. The middle board is locked on the top face of the bottom board. The middle board is formed with multiple connecting holes for multiple locating members to fit therein. The locating members protrude from the top face of the middle board. The top board is mounted on the top face of the middle board. The top board is formed with multiple locating holes respectively corresponding to the locating members. The locating members are respectively passed through the locating holes to protrude from the top board. A press shank and a latch ring are pivotally disposed on the top board. When pressing down the press shank, the latch ring is tightly latched with the locating members to fixedly connect the top board with the middle board.

### BACKGROUND OF THE INVENTION

The present invention is related to a nail guiding mechanism of nailing gun, which can be easily manufactured at low cost.

FIGS. 5 to 7 show a conventional nailing gun having a gun body 81 and a nail magazine 82. A nail guiding mechanism 9 is disposed between the gun body 81 and the nail magazine 82. The nail guiding mechanism 9 is composed of a seat body 91 and a cover board 90.

One end of the seat body 91 is locked on the gun body 81. The nail magazine 82 is locked under the bottom face of the seat body 91. The central portion of the seat body 91 is formed with a nail accommodating hole 911. The top face of the seat body 91 is formed with a slide channel 913 for a nail striking member (not shown) to strike out a row of nails (not shown) loaded in the nail magazine 82.

The end of the seat body 91 near the gun body 81 is formed with two engaging blocks 92 respectively disposed on two sides of the slide channel 913. The other end of the seat body 91 distal from the gun body 81 is formed with two engaging hooks 93 respectively disposed on two sides of the slide channel 913. Each engaging block 92 has an inclined stop face 921 proximal to the gun body 81. One end of each engaging hook 93 distal from the seat body 91 is formed with a hook section 931.

The cover board 90 is formed with four through holes 901 respectively corresponding to the engaging blocks 92 and the engaging hooks 93 for the same to pass through the cover board 90. A press shank 95 is pivotally disposed on the cover board 90. A latch ring 96 is pivotally connected with the press shank 95. When the cover board 90 is mated with the seat body 91 to cover the top face 912 thereof, the latch ring 96 is hooked by the hook sections 931 of the engaging hooks 93 and the press shank 95 is pressed down to tightly latch the latch ring 96 with the engaging hooks 93. Also, the stop faces 921 of the engaging blocks 92 abut against the cover board 90 so as to fixedly connect the cover board 90 with the seat body 91.

In the above structure, the engaging blocks 92 and the engaging hooks 93 are integrally formed on the seat body 91. The engaging blocks 92 and the engaging hooks 93 are respectively formed with inclined stop faces 921 and hook sections 931. This makes the seat body 91 have a complicated profile. Therefore, the seat body 91 needs to be molded by way of precise dewaxing casting so as to ensure necessary strength and precision.

The precise dewaxing casting leads to quite high manufacturing cost and high price of the nailing gun. Therefore, it is necessary to provide a nail guiding mechanism which can be made by a common processing measure so as to lower manufacturing cost.

### SUMMARY OF THE INVENTION

It is therefore a primary object of the present invention to provide a nail guiding mechanism of nailing gun. The nail guiding mechanism includes a bottom board, a middle board and a top board. The bottom board is connected between the gun body and the nail magazine. The middle board is formed with multiple connecting holes for multiple locating members to fit therein. The top board is formed with multiple locating holes respectively corresponding to the locating members. The locating members are respectively passed through the locating holes to protrude from the top board. A press shank and a latch ring are pivotally disposed on the top board. When pressing down the press shank, the latch ring is tightly latched with the locating members to fixedly connect the top board with the middle board. The bottom board, middle board, top board and the locating members are independent members which can be made by way of punch. Accordingly, the manufacturing cost is greatly reduced.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a sectional view of a first embodiment of the nail guiding mechanism of the present invention;

FIG. 4 is a sectional view of a second embodiment of the nail guiding mechanism of the present invention;

FIG. 5 is a perspective assembled view of a conventional nailing gun;

FIG. 6 is a perspective exploded view of the nail guiding mechanism of the conventional nailing gun; and

FIG. 7 is a sectional view of the nail guiding mechanism of the conventional nailing gun.

### DETAILED DESCRIPTION OF THE PREFERRED EMBODIMENTS

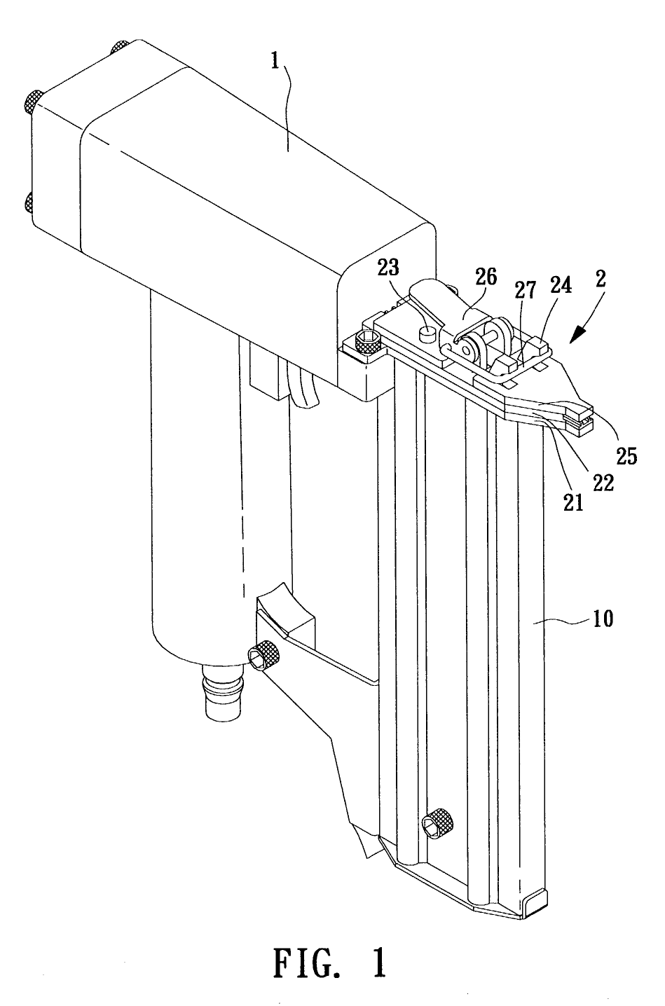

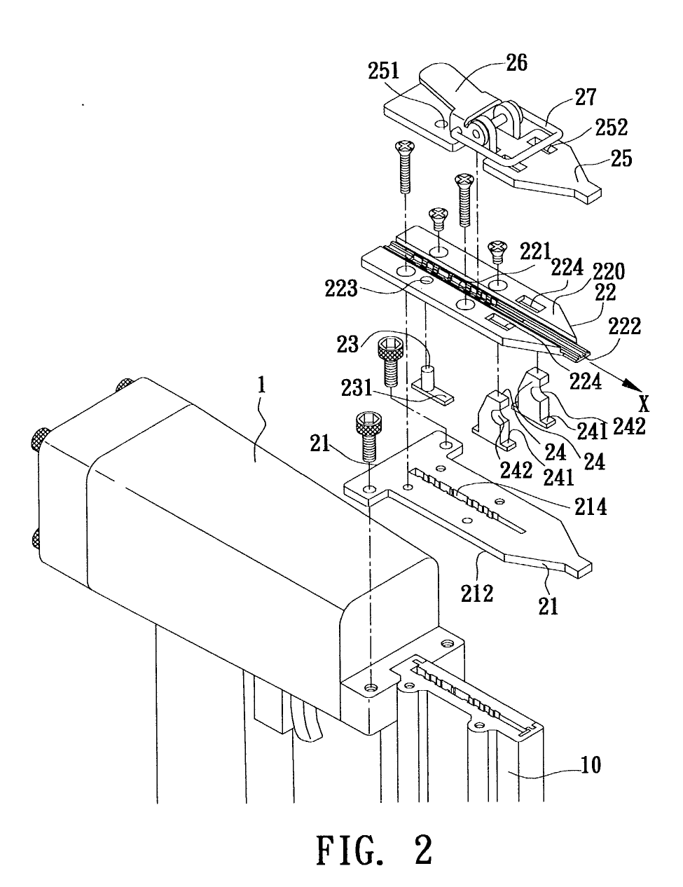

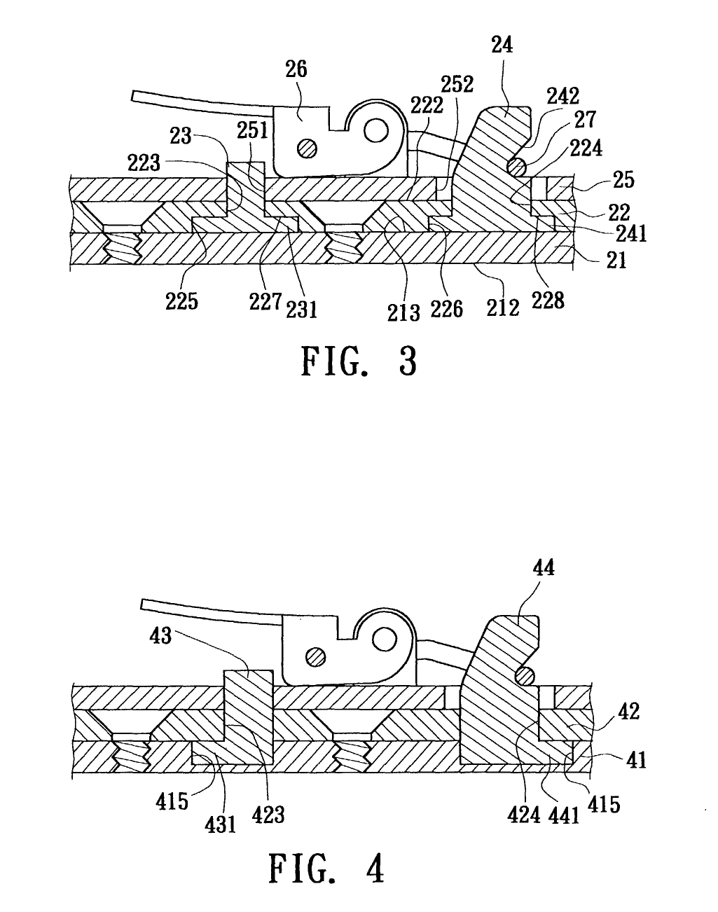

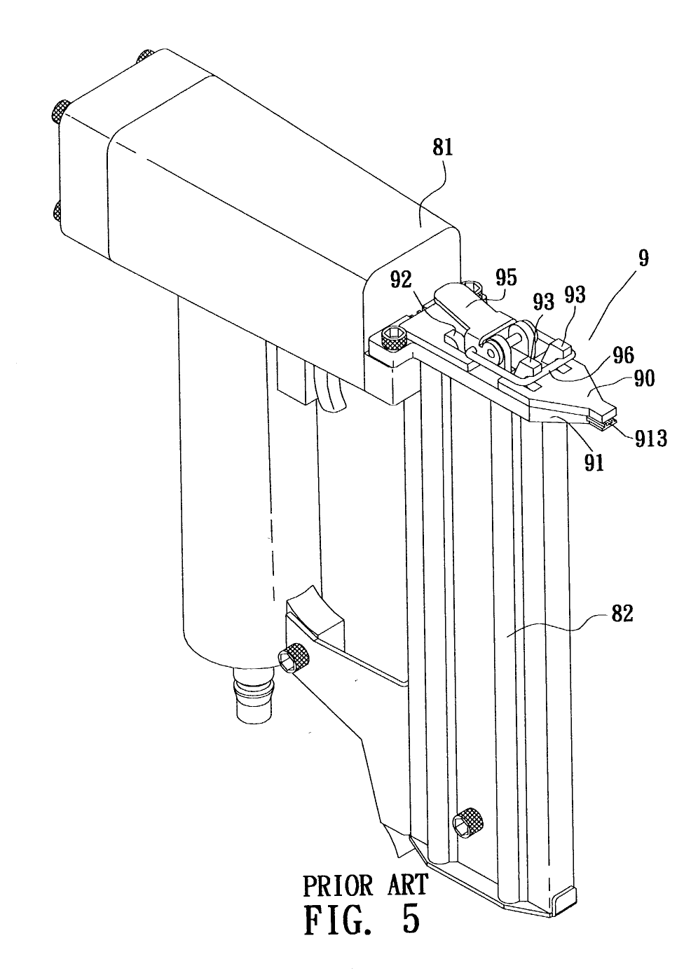

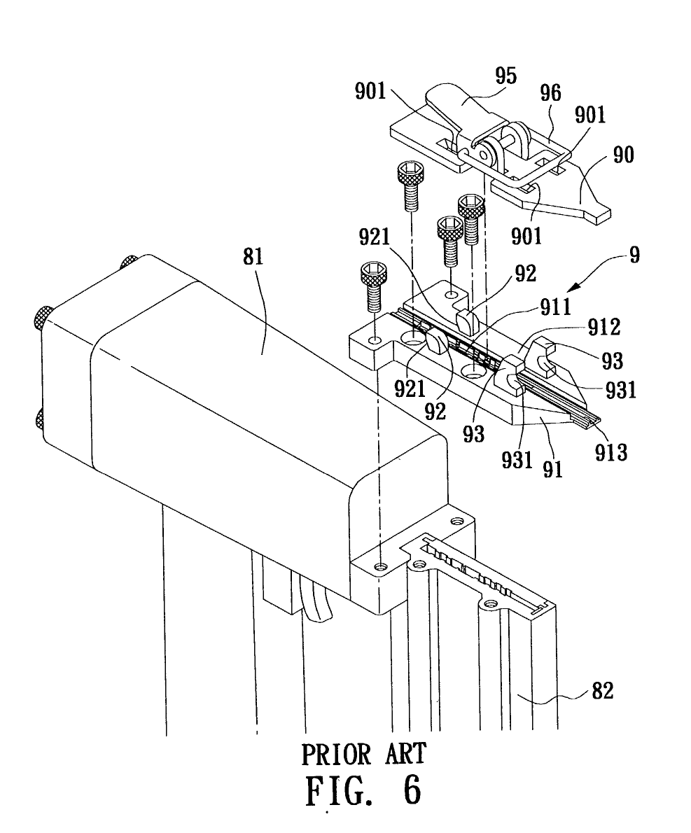

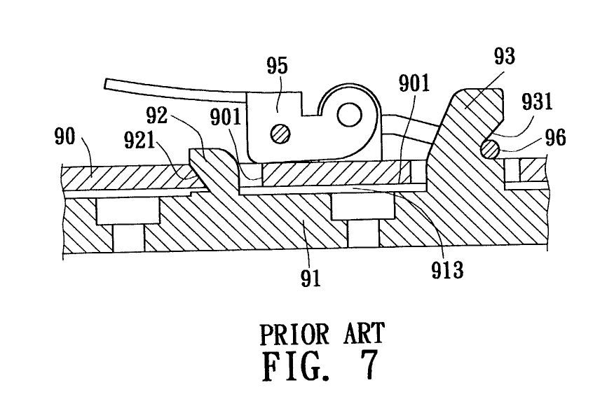

Please refer to FIGS. 1 to 3. The present invention discloses a nail guiding mechanism of a nailing gun. The nailing gun is composed of a gun body 1, a nail magazine 10 and the nail guiding mechanism 2.

The nail guiding mechanism 2 includes a bottom board 21, a middle board 22 and a top board 25.

The bottom board 21 has a rear end 211 for locking on the gun body 1. The bottom board 21 further has a bottom face 212 and a top face 213 opposite to the bottom face 212. The nail magazine 10 is locked under the bottom face 212 of the bottom board 21. The central portion of the bottom board 21 is formed with a nail accommodating slot 214 passing through the bottom board 21 from the top face 213 to the bottom face 212.

The middle board 22 is locked on the top face 213 of the bottom board 21. The middle board 22 is formed with a nail accommodating section 221 passing through the middle board 22 corresponding to the nail accommodating slot 214 of the bottom board 21. The middle board 22 has a face connecting with the bottom board 21 and a top face 220 opposite to the face connecting with the bottom board 21. The top face 220 is formed with a slide channel 222 extending in a lengthwise direction X of the nail accommodating section 221.

One end of the middle board 22 near the gun body 1 is formed with a first connecting hole 223 for a locating member to fit therein. In this embodiment, the locating member is a tenon 23 upward protruding from the top face 220 of the middle board 22. The other end of the middle board 22 distal from the gun body 1 is formed with two second connecting holes 224 respectively on two sides of the slide channel 222. A locating member is fitted in each second connecting hole 224. In this embodiment, the locating member is an engaging hook 24 upward protruding from the top face 220 of the middle board 22. The protruding end of the engaging hook 24 is formed with a hook section 242.

One end of each of the first and second connecting holes 223, 224 adjacent to the bottom board 21 is formed with an enlarged section 225, 226. A stop face 227, 228 is formed between the enlarged section 225, 226 and the first and second connecting hole 223, 224. Each of the tenon 23 and the engaging hooks 24 is formed with a stop section 231, 241 corresponding to the enlarged section 225, 226. The stop sections 231, 241 of the tenon 23 and the engaging hooks 24 are clamped between the stop faces 227, 228 and the bottom board 21 and located in the first and second connecting holes 223, 224.

The top board 25 is mounted on the top face 220 of the middle board 22. The top board 25 is formed with a first locating hole 251 and two second locating holes 252. The tenon 23 and the engaging hooks 24 are respectively passed through the first and second locating holes 251, 252 to protrude from the top board 25.

A press shank 26 is pivotally disposed on one face of the top board 25 opposite to the other face connecting with the middle board 22. A latch ring 27 is pivotally connected with the press shank 26. The latch ring 27 is hooked by the hook sections 242 of the engaging hooks 24. When pressing down the press shank 26, the latch ring 27 is tightly latched with the engaging hooks 24. At the same time, the tenon 23 abuts against the top board 25 to fixedly connect the top board 25 with the middle board 22.

It should be noted that in the present invention, the tenon 23 and engaging hooks 24 and the bottom board 21 and middle board 22 are designed as independent members instead of the integrated structure in the conventional nail guiding mechanism. Therefore, the tenon 23 and engaging hooks 24 and the bottom board 21 and middle board 22 can be all made by way of punch. The top board 25 is also made by punching as in the conventional nail guiding mechanism. Accordingly, the manufacturing cost is greatly reduced.

The tenon 23 and engaging hooks 24 and the bottom board 21 and middle board 22 are connected in such a manner that prior to connection between the middle board 22 and the bottom board 21, the tenon 23 and the engaging hooks 24 are respectively passed through the first and second connecting holes 223, 224 of the middle board 22 to protrude from the top face 220 thereof. When locking the middle board 22 on the bottom board 21, the stop sections 231, 241 of the tenon 23 and the engaging hooks 24 are fixedly clamped between the bottom board 21 and the stop faces 227, 228 to keep a certain connection strength.

FIG. 4 shows a second embodiment of the present invention, in which the first and second connecting holes 423, 424 of the middle board 42 have no enlarged section as in the first embodiment. The bottom board 41 is formed with locating dents 415 respectively corresponding to the first and second connecting holes 423, 424. Each locating dent 415 has a cross-section larger than that of the first and second connecting holes 423, 424. The stop sections 431, 441 of the tenon 43 and the engaging hooks 44 are received in the locating dents 415 and clamped by the middle board 42 and the bottom board 41. This can achieve the same function as the first embodiment.

The above embodiments are only used to illustrate the present invention, not intended to limit the scope thereof. Many modifications of the above embodiments can be made without departing from the spirit of the present invention.

What is claimed is:

1. A nail guiding mechanism of nailing gun composed of a gun body, a nail magazine and the nail guiding mechanism, said nail guiding mechanism comprising:
a bottom board connected with the gun body, the bottom board having a bottom face and a top face opposite to the bottom face, the nail magazine being locked under the bottom face of the bottom board, a central portion of the bottom board being formed with a nail accommodating slot passing through the bottom board from the top face to the bottom face;
a middle board locked on the top face of the bottom board, the middle board being formed with a nail accommodating section passing through the middle board corresponding to the nail accommodating slot of the bottom board, the middle board having a face connecting with the bottom board and a top face opposite to the face connecting with the bottom board, the top face being formed with a slide channel extending in a lengthwise direction of the nail accommodating section, one end of the middle board near the gun body being formed with more than one first connecting hole, the other end of the middle board distal from the gun body being formed with more than one second connecting hole;
multiple first and second locating members each having a stop section, the first and second locating members being respectively fitted through the first and second connecting holes from the face of the middle board connecting with the bottom board and protruding from the top face of the middle board; and
a top board mounted on the top face of the middle board, the top board being formed with first and second locating holes respectively corresponding to the first and second locating members, the first and second locating members being respectively passed through the first and second locating holes to protrude from the top board, a press shank being pivotally disposed on one face of the top board opposite to the other face connecting with the middle board, a latch ring being pivotally connected with the press shank, the latch ring being hooked by the second locating members, whereby when pressing down the press shank, the latch ring is tightly latched with the second locating members and the first locating members abut against the top board to fixedly connect the top board with the middle board.

2. The nail guiding mechanism of nailing gun as claimed in claim 1, wherein the end of the middle board near the gun body is formed with two first connecting hole respectively on two sides of the slide channel and the other end of the middle board distal from the gun body is formed with two second connecting holes respectively on two sides of the slide channel.

3. The nail guiding mechanism of nailing gun as claimed in claim 1, wherein an end of each of the first and second connecting holes adjacent to the bottom board is formed with an enlarged section, a stop face being formed between the enlarged section and the first and second connecting hole, the stop section of each of the first and second locating members being received in the enlarged section, whereby the stop section is clamped between the stop face and the bottom board and located in each of the first and second connecting holes.

4. The nail guiding mechanism of nailing gun as claimed in claim 1, wherein the bottom board is formed with multiple locating dents respectively corresponding to the first and second connecting holes, each locating dent having a cross-section larger than that of the first and second connecting holes, the stop sections of the first and second locating members being received in the locating dents, whereby the middle board abuts against the stop sections of the first and second locating members to locate the locating members in the connecting holes.

5. The nail guiding mechanism of nailing gun as claimed in claim 1, wherein an end of the second locating member protruding from the middle board is formed with a hook section for hooking the latch ring.
